(19) United States
(12) Patent Application Publication
(10) Pub. No.: US 2017/0347637 A1
(43) Pub. Date: Dec. 7, 2017

(54) Fishing Gaff

(71) Applicant: Acme United Corporation, Fairfield, CT (US)

(72) Inventor: Richard S. Constantine, Monroe, CT (US)

(21) Appl. No.: 15/171,239

(22) Filed: Jun. 2, 2016

(51) Int. Cl. A01K 97/14; A01K 99/00; A01K 83/00

(52) U.S. Cl. CPC A01K 97/14; A01K 83/00; A01K 99/00

(57) ABSTRACT

A fishing gaff incorporates a mechanism which selectively releases the hook from a tubular shaft. A button at an end of the shaft opposite the hook is depressed to release the hook. In one embodiment, an actuator of a release engages a plurality of locking jaws to spread same and release the hook.

### BACKGROUND

This disclosure relates generally to a fishing gaff. More particularly, this disclosure relates to a sophisticated fishing gaff which is adapted to land a large gamefish.

A number of improvements to traditional fishing gaff technology have been advanced. For example, U.S. Pat. No. 8,683,734 of the present applicant discloses a fishing gaff having a handle and an offset portion. A shaft extends from the offset portion. Spaced openings in the shaft facilitate movement through the water.

### SUMMARY

Briefly stated, a fishing gaff comprises an elongated tubular body having opposed first and second end portions. A coupler having a releasable lock is disposed at the first end portion and has a longitudinally extending receiving bore. A hook has a shank. The shank is receivable in the bore and releasably lockable to the body by the coupler. A release is received in the tubular body and has an actuator at one end and a button at a second end. The release is spring biased toward the second end portion. The hook is locked by the coupler when the button is in an inactivated locked mode and the button is depressible to force the actuator to engage the releasable lock and release the hook from the tubular body.

The coupler further comprises a plurality of jaws which engage the shank. The actuator comprises an angled surface portion which engages the jaws to spread the jaws apart. Each jaw comprises a locking lug and the shank has a recess which axially retains the locking lug. The actuator comprises a truncated conical surface. The button projects axially outwardly from the body in a locked mode of the hook. The hook preferably has an eyelet.

A fishing gaff comprises an elongated tubular body having opposed first and second end portions. A coupler has a releasable lock disposed at the first end portion. A hook having a shank is releasably lockable to the body by the coupler. A release is received in the tubular body and has an actuator at one end and a button at a second end. The hook is locked by the coupler when the button is in an inactivated locked mode and the button is actuatable to force said actuator to engage the releasable lock and release the hook from the tubular body.

The coupler comprises a plurality of jaws which engage the shank. The activator has an angled portion which engages the jaws and spreads the jaws apart. Each jaw has a locking lug and the shank has a recess which axially retains the locking lug.

A gaff comprises an elongated tubular body with opposed first and second end portions. A hook having a shank is releasably lockable to the body by the coupler which is disposed at the first end portion. A spring loaded release assembly is received in the tubular body and has an actuator and a manual release member which has a locked mode and a release mode. The hook is locked by the coupler when the release member is in the locked mode. The release member is transformable to force the actuator to engage the releasable lock and release the hook from the tubular body of the shaft.

The coupler has a plurality of jaws which engage the connector. The actuator comprises an angled surface portion which engages the jaws to disengage the jaws from the shank of the hook. The release member is biased by a spring to project outwardly from the shaft body in the locked mode of the hook.

### BRIEF DESCRIPTION OF THE DRAWINGS

FIG. 1 is a perspective view of a fishing gaff;

FIG. 2 is a top plan view of the fishing gaff of FIG. 1;

FIG. 3 is a partial sectional view of the fishing gaff of FIG. 2, taken along the line A-A thereof;

FIG. 4 is an enlarged view of a designated portion of the fishing gaff of FIG. 3;

FIG. 5 is an enlarged sectional view of a right end portion of the fishing gaff of FIG. 3;

FIG. 6 is an enlarged fragmentary view, portions removed to illustrate a hook/lock mode and portions in section, of the fishing gaff of FIG. 1;

FIG. 7 is an enlarged fragmentary view, portions removed to illustrate a hook/release mode and portions in section, of the fishing gaff of FIG. 6;

FIG. 8 is a composite schematic side view, portions in section and enlarged, illustrating the hook/lock mode of the fishing gaff of FIG. 1;

FIG. 9 is an annotated schematic side view, portions in section and enlarged, illustrating the hook/release mode for the fishing gaff of FIG. 1;

FIG. 10 is an enlarged fragmentary perspective view, portions removed, illustrating the fishing gaff of FIG. 1 in a hook/lock mode;

FIG. 11 is an enlarged fragmentary end perspective view of the fishing gaff for the hook/lock mode of FIG. 10; and

FIG. 12 is an enlarged fragmentary perspective opposed end view of the fishing gaff of FIG. 10.

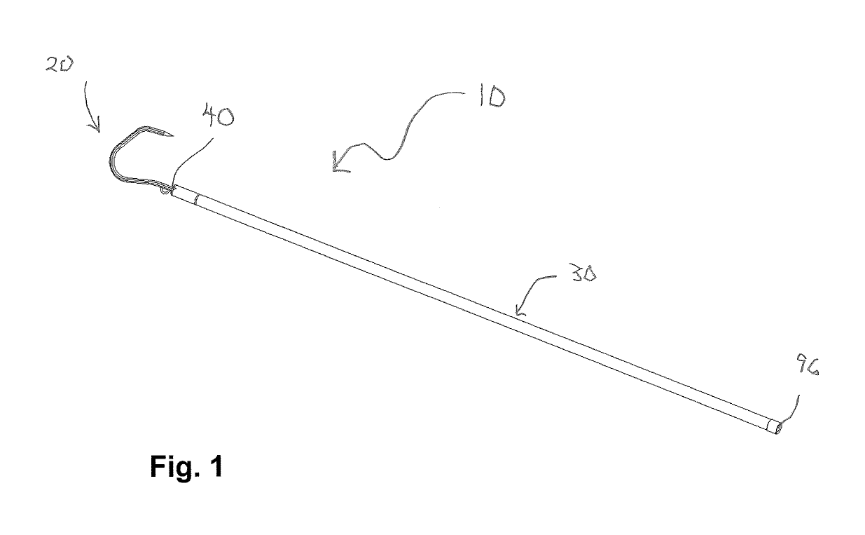

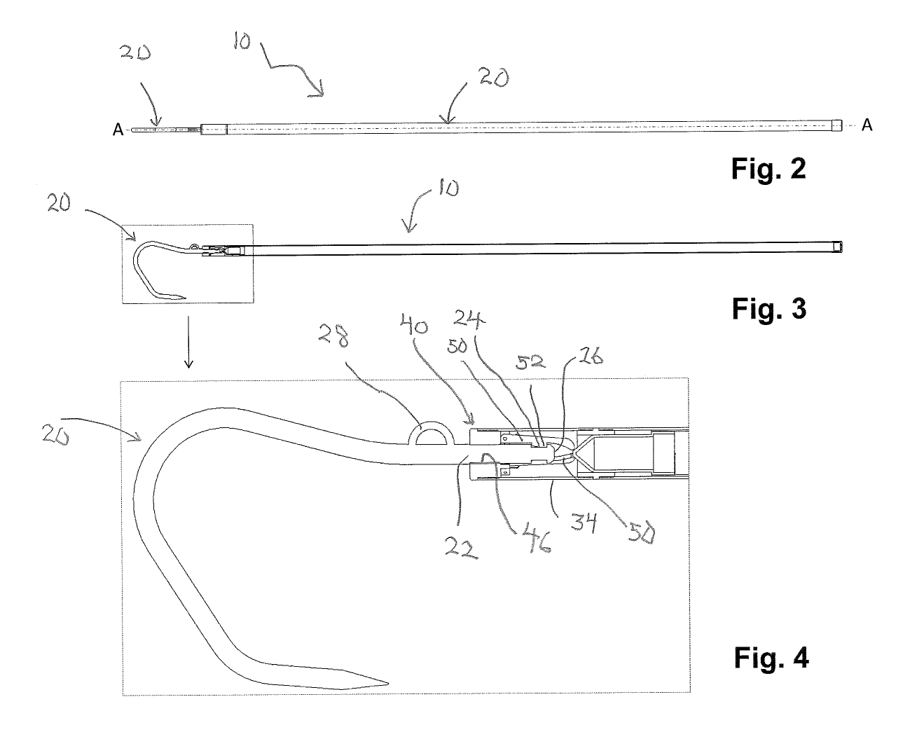

### DETAILED DESCRIPTION

With reference to the drawings wherein like numerals represent like parts throughout the figures, a fishing gaff is generally designated by the numeral 10. The fishing gaff includes a hook 20 and a tubular shaft 30 constructed from sturdy materials of high structural integrity so as to be capable of landing gamefish of significant magnitude. The fishing gaff 10 functions to allow the hook 20 to be selectively released from the shaft 30 upon manual actuation by the operator, as will be detailed below. The shaft 30 has multiple components, including an outer tube 32 and a tubular extension 34.

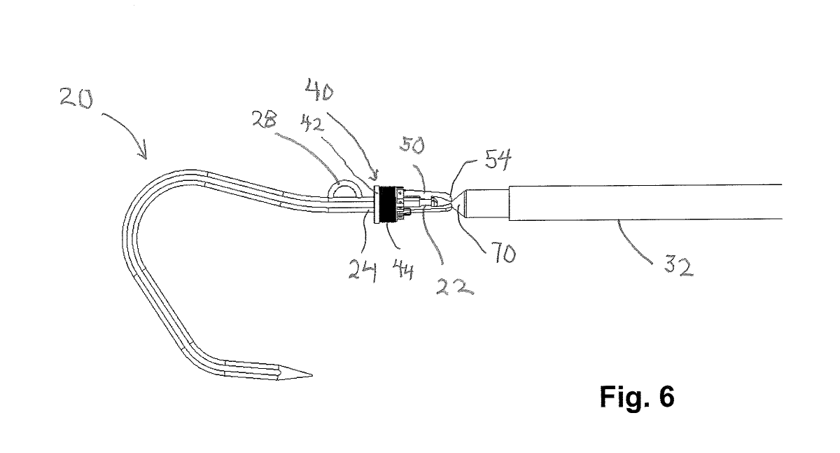

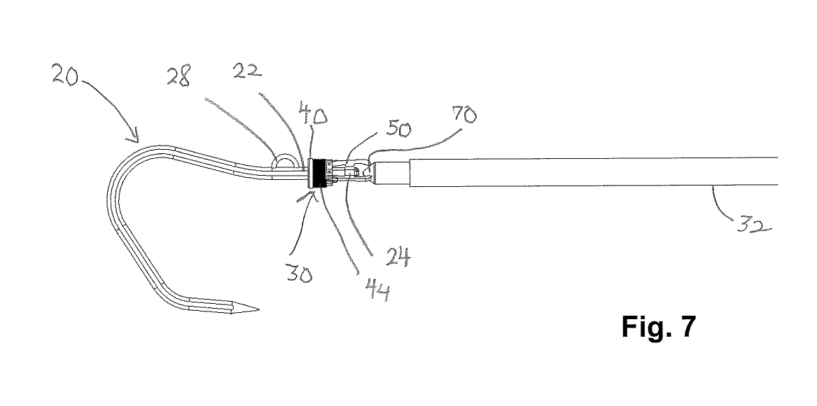

With reference to FIGS. 4, 6 and 7, the hook 20 has a compound bend with a rod-like axial shank 22. The shank 22 includes a recessed locking groove 24 which preferably circumferential extends around the shank axis and has a uniform depth and axial dimension. The shank terminates in a nose-like terminus 26. The hook 20 may also include an eyelet 28 for attachment of a lanyard (not illustrated) to retain the hook upon release from the shaft 30.

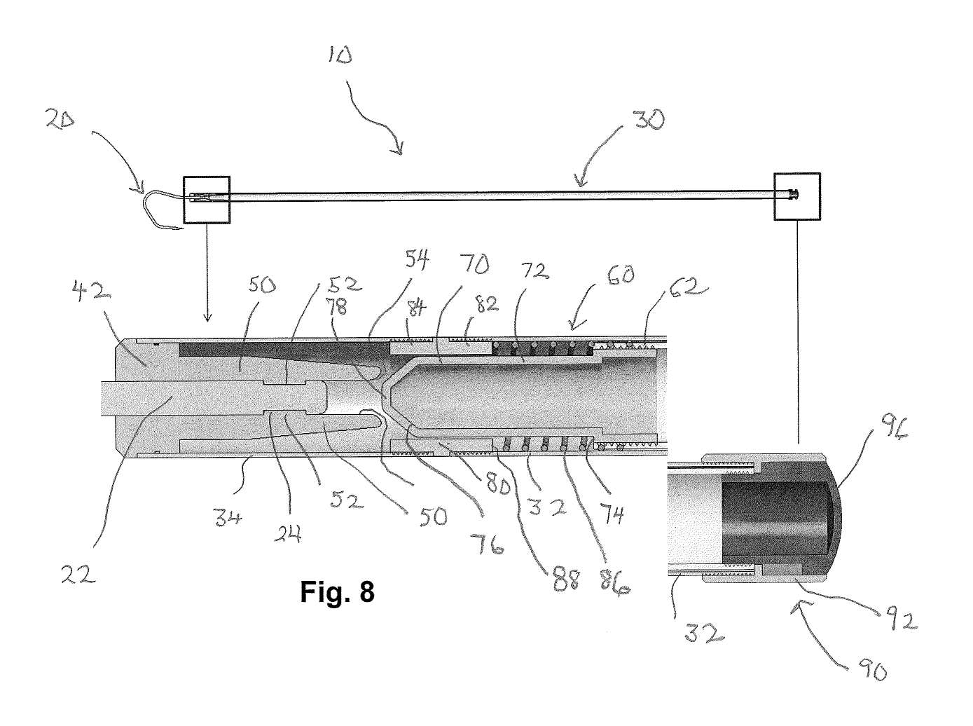

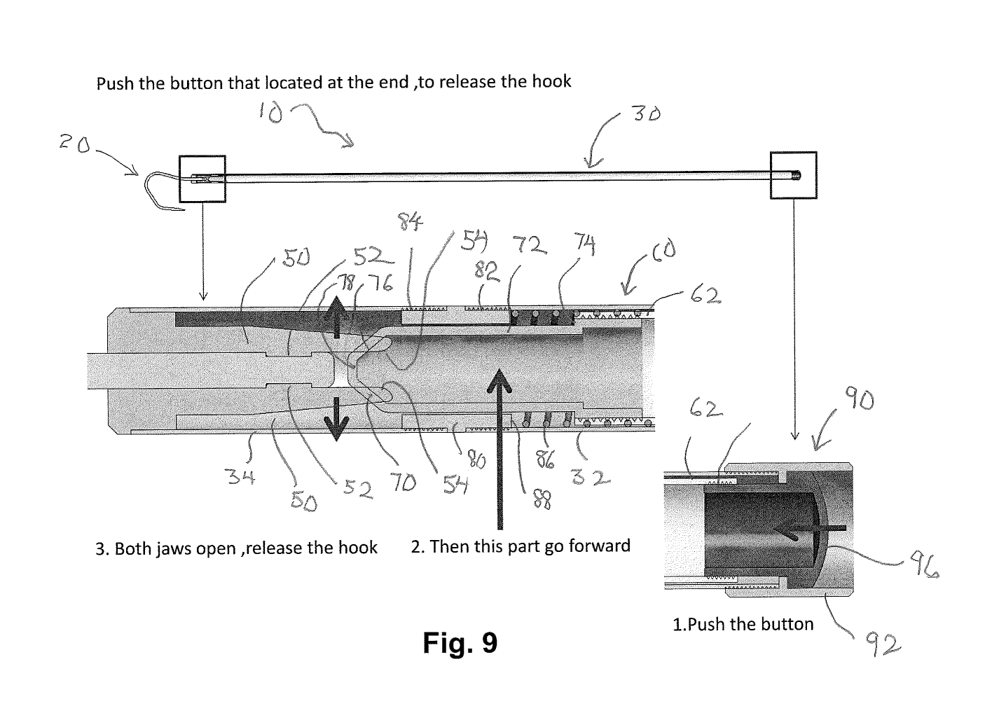

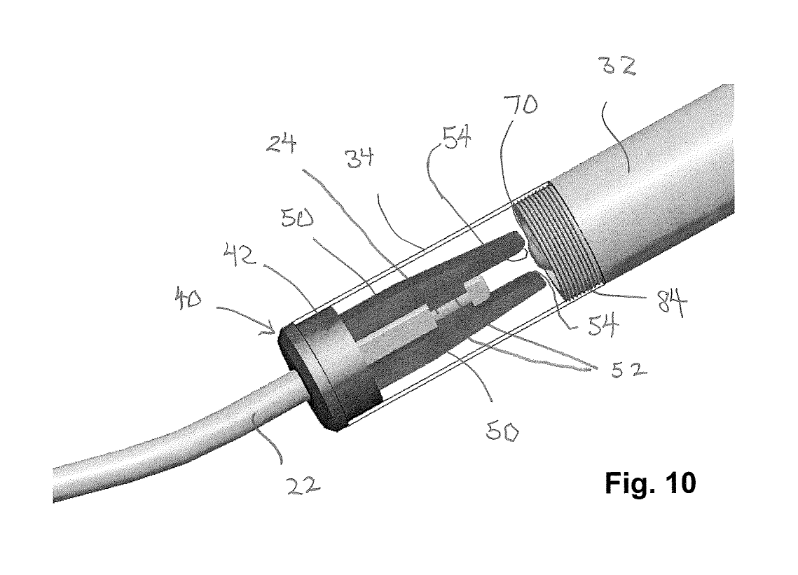

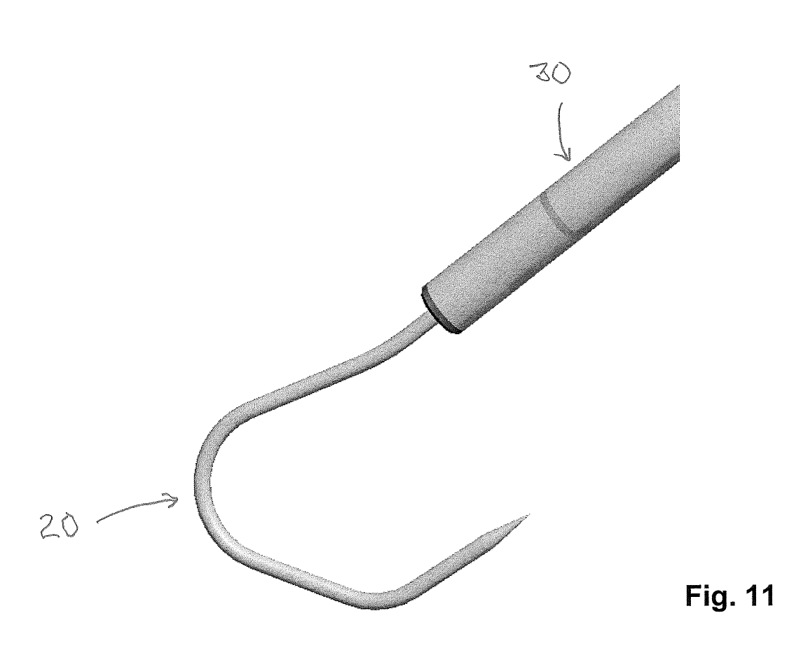

A coupler 40 includes a base 42 having a circumferential thread 44 which threads into one end of the tubular shaft 30. The coupler 40 has a central axial bore 46 which closely receives the hook shank 22. With additional reference to FIGS. 8 and 9, a plurality of pivotal arm-like jaws 50 each have an intermediate locking lug 52. Each lug 52 is dimensioned and positioned to engage into the locking groove 24 of the hook shank. The jaws 50 are pivotally mounted to the coupler base 42 and/or are resiliently biased toward each other and toward the axial center line of the receiving bore 46. Two, three, four or other numbers of locking jaws may be provided. The distal end 54 of each of the jaws has a smooth contoured surface. When the hook shank 22 is inserted into the receiving bore 46 of the coupler, the jaws 50 are biased inwardly and each end 54 is contoured so that each locking lug 52 rides over the shank until it aligns with the locking groove 24, in which instance, the lugs 52 are biased for engagement into the locking groove to lock the hook to the shaft in a fixed axial position.

With additional reference to FIGS. 4 and 8, a release assembly 60 includes an elongated tube 62 of reduced diameter relative to tube 32 is disposed inside and generally coaxial with the outer tube 32. Tube 62 is adapted for limited longitudinal displacement within tube 32. The distal end of the release tube interiorly threadably connects with a quasi-bullet-shaped actuator 70. The actuator 70 has a generally cylindrical surface 72 which extends from an annular shoulder 74 with a reduced diameter and terminates in a truncated conical end surface 76 (FIGS. 8 and 9). The end surface inwardly tapers and terminates in a substantially snub nose 78 which axially engages between the ends of the jaws 50. When the release tube 62 and the actuator 70 carried by the tube are longitudinally displaced toward the hook, the actuator 70 engages between the interior end portions of the jaws 50 and the conical surface 76 forces the jaws to spread apart radially so that the lugs 52 disengage from the locking groove 24 and the hook 20 may be released from the shaft of the gaff.

A quasi-cylindrical connector 80 includes a pair of longitudinally spaced threaded surfaces 82 and 84 which thread into the interior outer shaft tube 32 and a tubular extension 34 which secures the coupler 40 to the shaft 30. A coil spring 86 is engageable against an interior shoulder 88 of the connector and against a shoulder of the actuator 70 to spring bias the release assembly 60, including the tube 62, toward the proximal end of the outer tubular shaft 32.

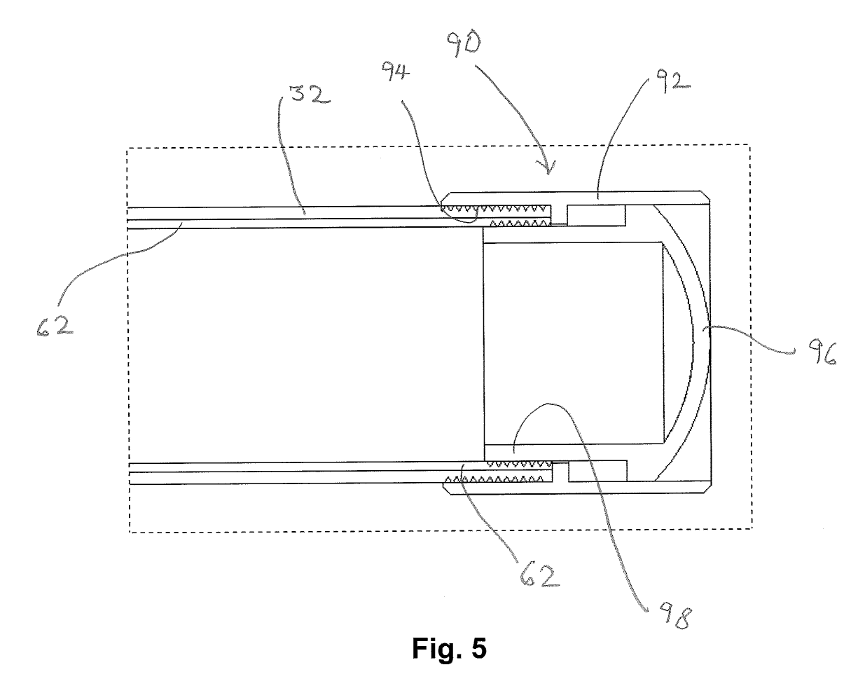

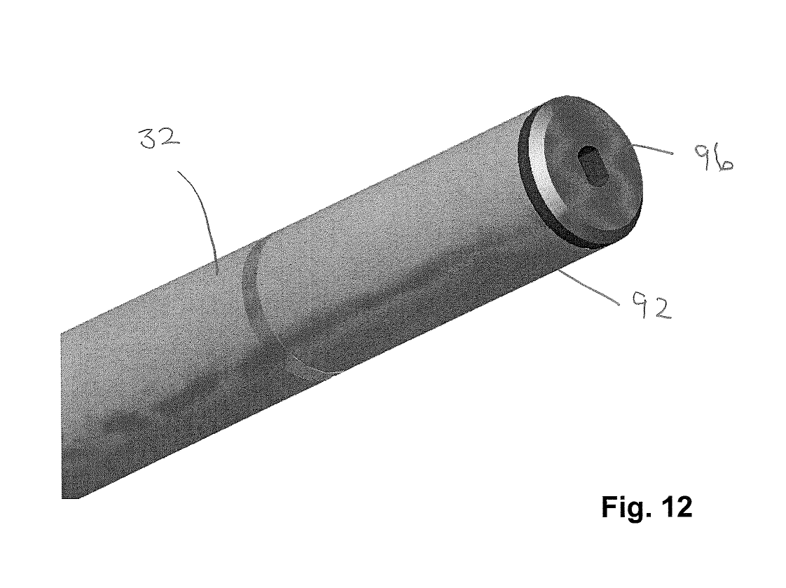

With additional reference to FIGS. 5, 8 and 9, a release button assembly 90 includes a cap 92. The cap 92 has an interior threaded surface 94 which threads to the outer end of the tubular shaft 32. A button 96 is received in an interior outer annulus of the cap and has a cylindrical inner wall 98 which threads into the interior end of the release tube 62. It will be appreciated that the button 96 is axially biased to an outer axial position. The button 96 may then be longitudinally moved axially or depressed toward the hook end so that the actuator 70 engages the jaws 50 to release the locking engagement of the hook 20. In the normal locked position, the button 96 is projected axially outwardly from the cap (FIG. 12). The spring 86 preferably exerts a significant force resisting depression of the release button 96 so that separation of the hook 20 is intentional on the part of the user and not inadvertent.

As best illustrated in FIG. 8, when the hook is locked to the shaft assembly, the actuator 70 is axially displaced from the jaws 50, and the button is in an extended position. As illustrated in FIG. 9, when it is desired to release the hook, the button is depressed in the direction of the lower FIG. 9 arrow. The latter forces the actuator 70 to engage the locking jaws 50 and force them outwardly, as illustrated by the opposed arrows and release the hook 20.

The hook shank 22 may then be reinserted into the coupler 40 and the locking jaws 50 reengage for securely locking the hook 20 to the shaft 30.

In an alternative embodiment, the lock/release modes may be reversed. The release button or operator is depressed by the user to maintain a lock mode for the hook, and released to separate the hook from the shaft. For this embodiment, the fisherman holds the operator while the hook is in the fish and then releases the hook from the shaft. Release mechanisms which employ operators other than buttons may also be incorporated into the fishing gaff.

While preferred embodiments of the foregoing have been set for purposes of illustration, the foregoing description should not be deemed a limitation of the invention herein. Accordingly, various modifications, adaptations and alternatives may occur to one skilled in the art without departing from the spirit and the scope of the present invention.

1. A fishing gaff comprising:
an elongated tubular body having opposed first and second end portions;
a coupler having a releasable lock disposed at said first end portion and defining a longitudinally extending receiving bore;
a hook having a shank receivable in said bore and releasably lockable to said body by said coupler;
a release received in said tubular body and having an actuator at one end and a button at a second end, said release being spring biased toward said second end portion;
wherein said hook is locked by said coupler when said button is in an inactivated locked mode, and said button is depressible to force said actuator to engage said releasable lock and release said hook from said tubular body.

2. The fishing gaff of claim 1 wherein said coupler further comprises a plurality of jaws which engage the shank.

3. The fishing gaff of claim 2 wherein said actuator comprises an angled surface portion which engages the jaws to spread the jaws apart.

4. The fishing gaff of claim 2 wherein each said jaw comprises a locking lug and said shank defines a recess which axially retains said locking lug.

5. The fishing gaff of claim 1 wherein said actuator comprises a truncated conical surface.

6. The fishing gaff of claim 1 wherein said button projects axially outwardly from said body in the locked mode of the hook.

7. The fishing gaff of claim 1 wherein said hook comprises an eyelet.

8. A fishing gaff comprising:
a shaft;
a hook mounted to said shaft;
a release assembly mounted to said shaft and selectively actuatable to release said hook from said shaft;
a hook having a shank releasably lockable to said body by said coupler;
a release received in said tubular body and having an actuator at one end and a button at a second end;
wherein said hook is locked by said coupler when said button is in an unactivated locked mode, and said button is actuatable to force said actuator to engage said releasable lock and release said hook from said tubular body.

9. The fishing gaff of claim 8 wherein said coupler further comprises a plurality of jaws which engage the shank.

10. The fishing gaff of claim 9 wherein said actuator comprises an angled portion which engages the jaws and spreads apart the jaws.

11. The fishing gaff of claim 9 wherein each said jaw comprises a locking lug and said shank defines a circumferential recess which axially retains said locking lug.

12. The fishing gaff of claim 8 wherein said actuator comprises a truncated conical surface.

13. The fishing gaff of claim 8 wherein said button projects axially outwardly from said body in the locked mode of the hook.

14. The fishing gaff of claim 8 wherein said hook comprises an eyelet.

15. A fishing gaff comprising:
an elongated body having opposed first and second end portions;
a coupler having a releasable lock disposed at said first end portion;
a hook having a shank releasably lockable to said body by said coupler;
a spring loaded release assembly received in said body and having an actuator and a manual release member having a locked mode and a release mode;
wherein said hook is locked by said coupler when said release member is in the locked mode, and said release member is transformable to force said actuator to engage said releasable lock and release said hook from said tubular body.

16. The fishing gaff of claim 15 wherein said coupler further comprises a plurality of jaws which engage the connector.

17. The fishing gaff of claim 16 wherein said actuator comprises an angled surface portion which engages the jaws to disengage the jaws from the shank.

18. The fishing gaff of claim 16 wherein each said jaw comprises a locking lug and said shank has a locking groove which axially retains said locking lug.

19. The fishing gaff of claim 15 wherein said actuator comprises a truncated conical surface.

20. The fishing gaff of claim 8 wherein said release member is biased by a spring to project axially outwardly from said body in the locked mode of the hook.

21. A fishing gaff comprising:
a shaft;
a hook mounted to said shaft; and
a release assembly mounted to said shaft and selectively transformable to release said hook from said shaft.

22. The fishing gaff of claim 21 wherein said hook is secured to said shaft by a releasable lock and said hook is released by transformation of an operator.

23. The fishing gaff of claim 22 wherein said releasable lock assembly comprises a plurality of members and said hook comprises a shank and wherein said members engage said shank to lock the hook to said shaft.

24. The fishing gaff of claim 23 wherein transforming said operator disengages said members from said shank.

25. The fishing gaff of claim 21 wherein said release assembly is transformable to release said hook from said shaft by selectively releasing a user actuatable operator.
